(19) United States
(12) Patent Application Publication
(10) Pub. No.: US 2007/0274689 A1
(43) Pub. Date: Nov. 29, 2007

(54) Method and apparatus for establishing audio/video formats for sink devices

(75) Inventor: Christopher J. Stone, Newtown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/115,029

(22) Filed: Apr. 26, 2005

(51) Int. Cl. H04N 5/91

(52) U.S. Cl. 386/123

(57) ABSTRACT

Method and apparatus for establishing audio/video (AV) formats for sink devices is described. In one example, a connection event is detected on a link between a source device and a sink device. AV capability data is received at the source device from the sink device in response to the connection event. For example, the AV capability data may be obtained at the source device by reading at least one of an extended display identification (EDID) data structure and an enhanced extended display identification (E-EDID) data structure. A determination is made whether the AV capability data is identical to prior AV capability data previously stored in the source device. If so, a first AV format of a signal transmitted from the source device to the sink device is maintained in accordance with the previously stored AV capability data. Otherwise, the AV capability data is parsed to determine a second AV format.

### BACKGROUND OF THE INVENTION

1. Field of the Invention

The present invention relates to audio/video systems and, more particularly, to a method and apparatus for establishing audio/video formats for sink devices.

2. Description of the Background Art

Audio/video (AV) systems generally include one or more source devices configured to provide AV signals, and one or more sink devices configured to process and display the AV signals. Each sink device in an AV system may require input AV signals to be in a specific format. For example, a sink device may be configured to accept high-definition television (HDTV) signals having a 720p format as opposed to a 480p or 1080i format. Presently, a source device utilizes a data structure stored in a sink device to determine the proper format of the AV signals. For example, the source device may be configured to read an extended display identification (EDID) or an enhanced extended display identification (E-EDID) data structure stored in the sink device. Such data structures store the various audio, video, and auxiliary data capabilities of the sink device.

There are currently two industry-wide practices for establishing the proper format of AV signals. In one technique, the source device reads the data structure once, sets the format, and then never changes the format again. In the other technique, the source device reads the data structure and sets the format every time a connection event occurs. One problem with the former technique is that, after the initial reading of the data structure and setting of the format, the user may connect a new sink device that does not support the already defined format. Thus, the user must manually change the format at the source device. One problem with the latter technique is that, if the selected format is undesirable to the user, and the user manually changes the format to his/her preference, the format will automatically revert to the undesirable format at every connection event (e.g., powering on/off the source device and/or the sink device). As such, the user must manually change the format back to the desired format every time a connection event occurs. Accordingly, there exists a need in the art for an improved method and apparatus for establishing audio/video formats for sink devices.

### SUMMARY OF THE INVENTION

Method and apparatus for establishing audio/video (AV) formats for sink devices is described. In one embodiment, a connection event is detected on a link between a source device and a sink device. AV capability data is received at the source device from the sink device in response to the connection event. In one embodiment, the AV capability data may be obtained at the source device by reading at least one of an extended display identification (EDID) data structure and an enhanced extended display identification (E-EDID) data structure. A determination is made whether the AV capability data is identical to prior AV capability data previously stored in the source device. If so, a first AV format of a signal transmitted from the source device to the sink device is maintained in accordance with the previously stored AV capability data. Otherwise, the AV capability data is parsed to determine a second AV format.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of an audio/video (AV) system constructed in accordance with one or more aspects of the invention;

FIG. 2 is a flow diagram depicting an exemplary embodiment of a method of setting the format of AV signals transmitted by a source device to a sink device in accordance with one or more aspects of the invention; and

FIG. 3 is a block diagram depicting an exemplary embodiment of a computer 300 suitable for implementing the processes and methods described herein.

To facilitate understanding, identical reference numerals have been used, where possible, to designate identical elements that are common to the figures.

### DETAILED DESCRIPTION OF THE INVENTION

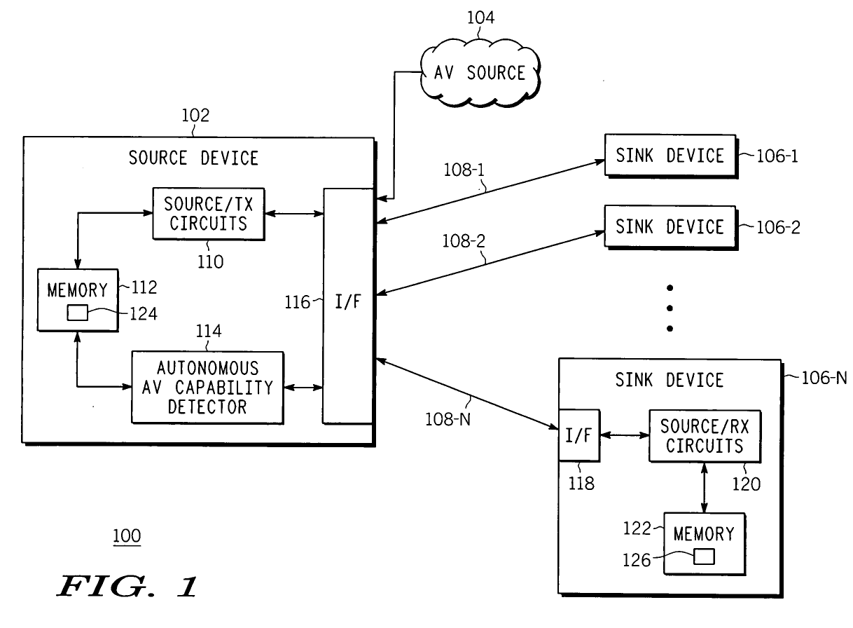

FIG. 1 is a block diagram depicting an exemplary embodiment of an audio/video (AV) system 100 constructed in accordance with one or more aspects of the invention. The AV system 100 includes a source device 102 and sink devices 106-1 through 106-N (collectively referred to as sink devices 106), where N is an integer greater than zero. The source device 102 is coupled to the sink devices 106-1 through 106-N via links 108-1 through 108-N. The source device 102 includes source and transmitter (source/TX) circuits 110, an autonomous AV capability detector 114, a memory 112, and an interface (I/F) 116. For purposes of clarity by example, only the sink device 106-N is shown in detail. It is to be understood that each of the sink devices 106-1 through 106-(N−1) include similar components. The sink device 106-N includes an interface (I/F) 118, sink and receiver (sink/RX) circuits 120, and a memory 122.

The source device 102 is configured to receive AV signals from an AV source 104 via the interface 116 (e.g., a terrestrial source, a cable television source, a satellite television source, a digital video recorder source, a digital versatile disc (DVD) source, and like-type sources of AV signals known in the art). The source/TX circuits 110 receive AV signals from the AV source 104 and transmit the AV signals to one or more of the sink devices 106 via the links 108. The source/TX circuits 110 comprise various AV circuits well-known in the art for receiving, processing, and/or transmitting AV signals. Each of the links 108 may comprise any type of AV link known in the art, such as a digital visual interface (DVI) link, a high-definition multimedia interface (HDMI) link, a DVI plus high-bandwidth digital content protection (DVI+HDCP) link, a DVI high-definition television (DVI-HDTV) link, and the like.

Each of the sink devices 106 is configured to receive AV signals from the source device 102 via the interface 118. The sink/RX circuits 120 are configured to receive and process the AV signals for display. The sink/RX circuits 120 comprise various AV circuits well-known in the art for receiving, processing, and displaying AV signals. For example, a sink device may comprise a television configured to display video/audio/data to a user. For each of the sink devices 106, the memory 122 is configured to store AV capability data 126. The memory 126 may comprise any type of memory known in the art. For example, the memory 126 may comprise a non-volatile memory, such as a read-only memory (ROM).

The AV capability data 126 may comprise, for example, at least one of an extended display identification (EDID) data structure and an enhanced extended display identification (E-EDID) data structure, as defined by the video electronics standards association (VESA). The formats of EDID and E-EDID data structures are standardized and well known in the art. The AV capability data 126 may also include one or more timing extension data structures, such as timing extensions defined by the consumer electronics associate (CEA) standard CEA-861B. In general, for each of the sink devices 106, the AV capability data 126 includes data associated with audio, video, and auxiliary data capabilities thereof.

The autonomous AV capability detector 114 is configured to detect the AV capability data 126 stored in each of the sink devices 106 in response to a connection event. In particular, when a sink device is connected to the source device 102, a connection event is triggered by the source device 102, the sink device, or both. The connection event may comprise, for example, a “hot plug” event. The connection event may be triggered when the source device 102 is connected to a sink device, and the source device 102 and/or the sink device is powered on. In response to the connection event, the autonomous AV capability detector 114 reads the AV capability data 126 from the memory 122. In one embodiment, the autonomous AV capability detector 114 receives the AV capability data 126 via a control channel implemented between the interface 116 and the interface 118. For example, the control channel may comprise a display data channel (DDC).

The memory 112 in the source device 102 is configured to store AV capability data 124 associated with sink devices. As each sink device is connected to the source device 102 for the first time, the source device 102 adds the AV capability data of the sink device to the AV capability data 124. In response to a connection event, the autonomous AV capability detector 114 receives the AV capability data of the sink device and compares it with the AV capability data 124. If the AV capability data from the sink device is found in the AV capability data 124, then the source/TX circuits 110 maintain the format of AV signals transmitted to the sink device as defined by the AV capability data 124 stored in the memory 112. If the AV capability data from the sink device is not found in the AV capability data 124, then the source/TX circuits 110 parse the sink device AV capability data to determine a format for AV signals transmitted to the sink device. The AV capability data for the sink device is then added to the AV capability data 124.

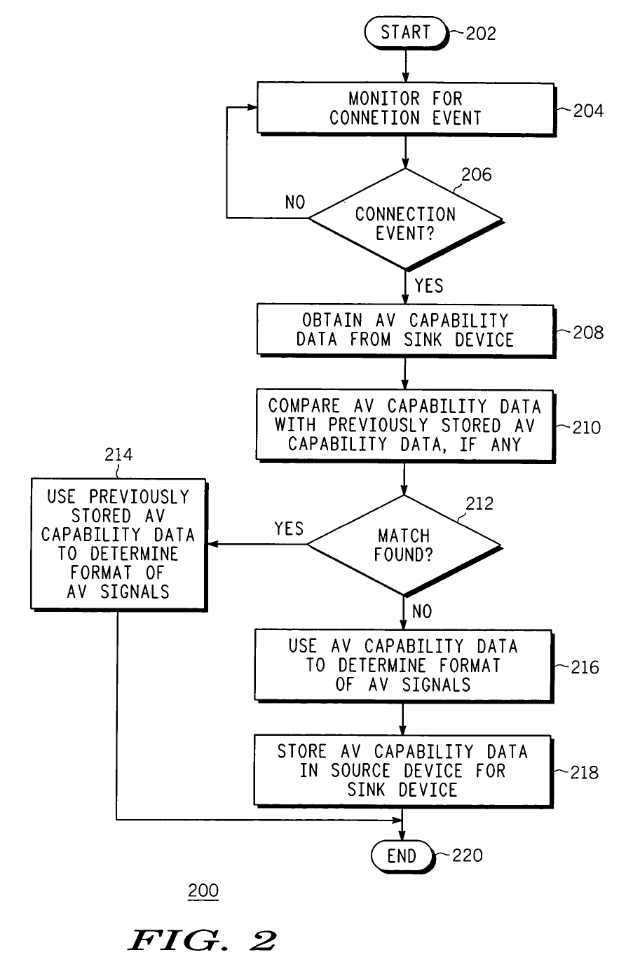

FIG. 2 is a flow diagram depicting an exemplary embodiment of a method 200 of setting the format of AV signals transmitted by a source device to a sink device in accordance with one or more aspects of the invention. The method 200 begins at step 202. At step 204, the source device monitors for a connection event. At step 206, a determination is made whether a connection event has occurred. If not, the method 200 returns to step 204. If a connection event is detected, the method 200 proceeds to step 208.

At step 208, AV capability data is obtained from the sink device. For example, the source device may read an EDID or an E-EDID data structure from the sink device to obtain the AV capability data. At step 210, the AV capability data is compared with previously stored AV capability data, if any, in the source device. At step 212, a determination is made whether the AV capability data obtained at step 208 matches any previously stored AV capability data in the source device. If so, the method 200 proceeds to step 214. At step 214, the previously stored AV capability data is used to determine the format of AV signals transmitted from the source device to the sink device. The method 200 then ends at step 220.

If, at step 212, the AV capability data obtained at step 208 does not match any previously stored AV capability data in the source device, the method 200 proceeds to step 216. At step 216, the AV capability data obtained at step 208 is used to determine the format of AV signals transmitted from the source device to the sink device. The format of the AV signals may be determined by parsing the AV capability data. At step 218, the AV capability data obtained at step 208 is stored in the source device for the sink device. The method then ends at step 220.

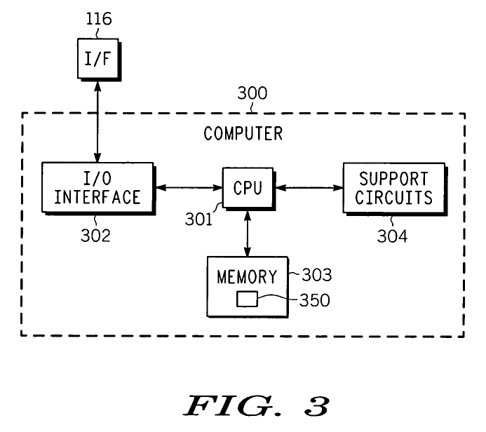

FIG. 3 is a block diagram depicting an exemplary embodiment of a computer 300 suitable for implementing the processes and methods described herein. Notably, the computer 300 may be part of the source device 102 in FIG. 1 and may be used to implement the autonomous AV capability detector 114. The computer 300 includes a central processing unit (CPU) 301, a memory 303, various support circuits 304, and an I/O interface 302. The CPU 301 may be any type of processor or microcontroller known in the art. The support circuits 304 for the CPU 301 include conventional cache, power supplies, clock circuits, data registers, I/O interfaces, and the like. The I/O interface 302 may be directly coupled to the memory 303 or coupled through the CPU 301. The I/O interface 302 is configured to receive AV capability data from sink devices. For example, the I/O interface 302 may be configured for communication with the interface 116 of the source device.

The memory 303 may store all or portions of one or more programs and/or data to implement the processes and methods described herein. The memory 403 may include one or more of the following random access memory, read only memory, magneto-resistive read/write memory, optical read/write memory, cache memory, magnetic read/write memory, and the like, as well as signal-bearing media as described below. Notably, the memory 303 may be configured to store software 350 for implementing the method 200 of FIG. 2. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. In a source device configured to provide a signal having a first audio/video (AV) format, a method, comprising:
(a) detecting a connection event on a link between the source device and a sink device;
(b) receiving AV capability data at the source device from the sink device in response to the connection event;
(c) determining whether the AV capability data is identical to prior AV capability data previously stored in the source device;
(d) if the AV capability data is identical to the prior AV capability data, maintaining the first AV format of the signal; and
(e) if the AV capability data is not identical to the prior AV capability data, parsing the AV capability data to determine a second AV format.

2. The method of claim 1, wherein step (e) further comprises:
(e1) using the second AV format for the signal.

3. The method of claim 1, wherein the connection event comprises a hot plug event.

4. The method of claim 1, wherein the link comprises at least one of a digital visual interface (DVI) link, a high-definition multimedia interface (HDMI) link, a digital visual interface plus high-bandwidth digital content protection (DVI+HDCP) link, and a digital visual interface high-definition television (DVI-HDTV) link.

5. The method of claim 1, wherein the AV capability data comprises at least one of an extended display identification (EDID) data structure and an enhanced extended display identification (E-EDID) data structure.

6. The method of claim 5, wherein the AV capability data further comprises at least one timing extension data structure.

7. The method of claim 1, wherein the AV capability data is received using a display data channel (DDC) of the link.

8. The method of claim 1, wherein step (e) further comprises:
(e1) storing the AV capability data in the source device.

9. In a source device configured to provide a signal having a first audio/video (AV) format, an apparatus, comprising:
a link interface for communicating with a sink device;
a memory device for storing first AV capability data; and
an autonomous AV capability detector, coupled to the link interface, for receiving second AV capability data from the sink device in response to a connection event at the link interface, determining whether the second AV capability data is identical to the first AV capability data, maintaining the first AV format of the signal if the second AV capability data is identical to the first AV capability data, and parsing the second AV capability data to determine a second AV format if the second AV capability data is not identical to the first AV capability data.

10. The apparatus of claim 9, wherein the autonomous AV capability detector is configured to use the second AV format for the signal if the second AV capability data is not identical to the first AV capability data.

11. The apparatus of claim 9, wherein the connection event comprises a hot plug event.

12. The apparatus of claim 9, wherein the link interface comprises at least one of a digital visual interface (DVI) link interface, a high-definition multimedia interface (HDMI) link interface, a digital visual interface plus high-bandwidth digital content protection (DVI+HDCP) link interface, and a digital visual interface high-definition television (DVI-HDTV) link interface.

13. The apparatus of claim 9, wherein each of the first and second AV capability data comprises at least one of an extended display identification (EDID) data structure and an enhanced extended display identification (E-EDID) data structure.

14. The apparatus of claim 13, wherein each of the first and second AV capability data further comprises at least one timing extension data structure.

15. The apparatus of claim 9, wherein the autonomous AV capability detector is configured to receive the second AV capability data using a display data channel (DDC) of the link interface.

16. The apparatus of claim 9, wherein the autonomous AV capability detector is configured to store the second AV capability data in the memory device if the second AV capability data is not identical to the first AV capability data.

17. An audio/video (AV) system, comprising:
a source device configured to provide an AV signal;
a sink device configured to process the AV signal;
a link configured to couple the source device to the sink device;
a memory device, disposed in the source device, for storing first AV capability data; and
an autonomous AV capability detector, disposed in the source device, for receiving second AV capability data from the sink device in response to a connection event, determining whether the second AV capability data is identical to the first AV capability data, maintaining a first AV format of the AV signal if the second AV capability data is identical to the first AV capability data, and parsing the second AV capability data to determine a second AV format if the second AV capability data is not identical to the first AV capability data.

18. The system of claim 17, wherein the autonomous AV capability detector is configured to store the second AV capability data in the memory device and use the second AV format for the AV signal.

19. The system of claim 17, wherein the link comprises at least one of a digital visual interface (DVI) link, a high-definition multimedia interface (HDMI) link, a digital visual interface plus high-bandwidth digital content protection (DVI+HDCP) link, and a digital visual interface high-definition television (DVI-HDTV) link.

20. The system of claim 17, wherein each of the first and second AV capability data comprises at least one of an extended display identification (EDID) data structure and an enhanced extended display identification (E-EDID) data structure.
